(19) United States
(12) Patent Application Publication
(10) Pub. No.: US 2012/0221315 A1
(43) Pub. Date: Aug. 30, 2012

(54) SYSTEM MODEL MANAGEMENT AND SUPPORT SYSTEM, SYSTEM MODEL MANAGEMENT AND SUPPORT METHOD, AND SYSTEM MODEL MANAGEMENT AND SUPPORT PROGRAM

(75) Inventor: Kazuo Yanoo, Minato-ku (JP)

(73) Assignee: NEC CORPORATION, Minato-ku, Tokyo (JP)

(21) Appl. No.: 13/504,787

(22) PCT Filed: Oct. 15, 2010
(86) PCT No.: PCT/JP2010/006129

§ 371 Date: Apr. 27, 2012

(30) Foreign Application Priority Data
Oct. 30, 2009 (JP) 2009-251078

(51) Int. Cl. G06F 9/44

(52) U.S. Cl. 703/21

(57) ABSTRACT

The present invention provides a system model management and support system that is capable of facilitating the management of a system model by identifying any difference between the system model and a real system. Conversion means 6 converts configuration information indicative of the configuration and settings of the real system into a model having the same expression form as the system model. The real system is actually operated as a system. The system model is used as a model representing the real system during the development of the real system. Difference extraction means 7 extracts any difference between the system model and the model converted from the configuration information by comparing the system model with the model converted from the configuration information.

### TECHNICAL FIELD

The present invention relates to a system model management and support system, a system model management and support method, and a system model management and support program. More particularly, the present invention relates to a system model management and support system, system model management and support method, and system model management and support program that make it easy for a system developer to judge whether a system model is maintained in a proper state.

### BACKGROUND ART

A system actually developed and operated is hereinafter referred to as a real system. When real systems are developed on an individual basis, a large number of processes, such as designing, are required. Therefore, the following procedure has been performed. A model represented by abstracting a real system is prepared. When another real system is to be developed from now, the model subjected to abstraction is reused, thereby reducing the number of processes required for designing and the like. A model represented through abstraction of the configuration and operation of a real system is hereinafter referred to as a system model.

An information system development test support system, which detects a software configuration failure, is described in Patent Document 1. However, a system model described in Patent Document 1 is prepared by associating software functions, which are to be implemented, with individual server uses appropriate for the software functions. In the information system development test support system described in Patent Document 1, any software configuration failure in a system to be tested can be detected with ease by generating data of comparison between test evaluation data about the system model and execution results of the system to be tested.

### CITATION LIST

### Patent Literature

### Patent Document 1

JP-A-2006-59108 (paragraphs 0015 and 0028)

### SUMMARY OF INVENTION

### Technical Problem

The system model is not always consistent with a real system that is based on the system model. If the system model is not modified and the real system is implemented in a manner different from the system model, the system model is inconsistent with the real system. For example, if an anti-spam appliance is implemented for email security in a situation where the system model does not include a description of the anti-spam appliance, the real system includes the anti-spam appliance that is not described in the system model. Hence, the system model is inconsistent with the real system.

Further, if the real system is modified without modification of the system model after the real system starts its operation, the system model becomes inconsistent with the real system.

The fact that there is the above-described inconsistency between the system model and the real system indicates that the system model does not accurately represent the latest status of the real system and is obsolete. It is preferred that the system model to be reused for reducing the number of design and other processes be not obsolete.

The system described in Patent Document 1 is capable of easily detecting a software configuration failure. However, it cannot detect whether the system model expressing the configuration and operation of the real system is obsolete.

The present invention has been made in view of the above circumstances and has an object to provide a system model management and support system, system model management and support method, and system model management and support program that facilitate the management of the system model by identifying any difference between the system model and the real system.

### Solution to Problem

A system model management and support system according to an exemplary aspect of the present invention includes conversion means and difference extraction means. The conversion means converts configuration information indicative of the configuration and settings of a real system into a model having the same expression form as a system model. The real system is actually operated as a system. The system model is used as a model representing the real system during the development of the real system. The difference extraction means extracts any difference between the system model and the model converted from the configuration information by comparing the system model with the model converted from the configuration information.

A system model management and support method according to an exemplary aspect of the present invention includes converting configuration information indicative of the configuration and settings of a real system, which is actually operated as a system, into a model having the same expression form as a system model, which is used as a model representing the real system during the development of the real system; and extracting any difference between the system model and the model converted from the configuration information by comparing the system model with the model converted from the configuration information.

A system model management and support program according to an exemplary aspect of the present invention causes a computer to perform a conversion process and a difference extraction process. The conversion process converts configuration information indicative of the configuration and settings of a real system into a model having the same expression form as a system model. The real system is actually operated as a system. The system model is used as a model representing the real system during the development of the real system. The difference extraction process extracts any difference between the system model and the model converted from the configuration information by comparing the system model with the model converted from the configuration information.

### Advantageous Effects of the Invention

When there is any difference between the system model and the real system, the present invention identifies the difference to facilitate the management of the system model.

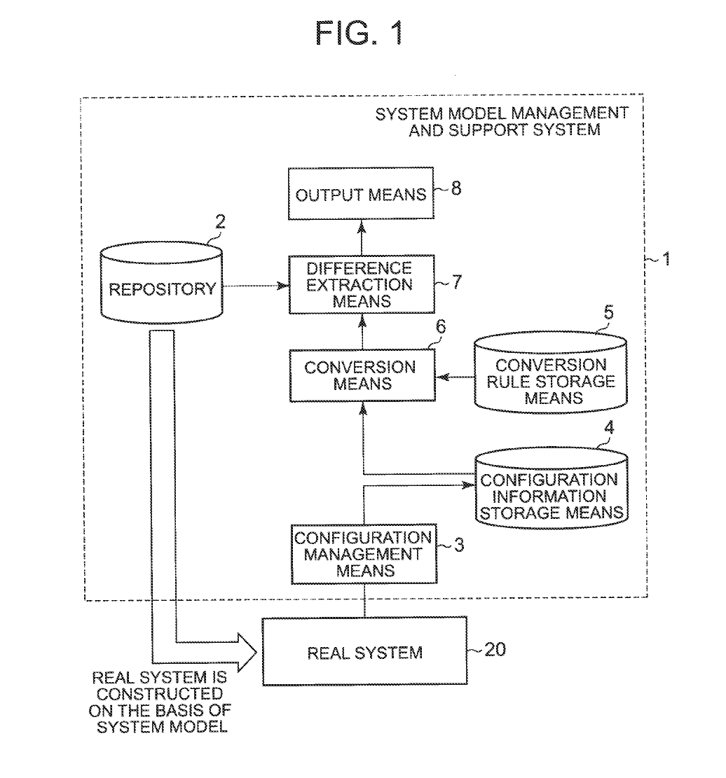

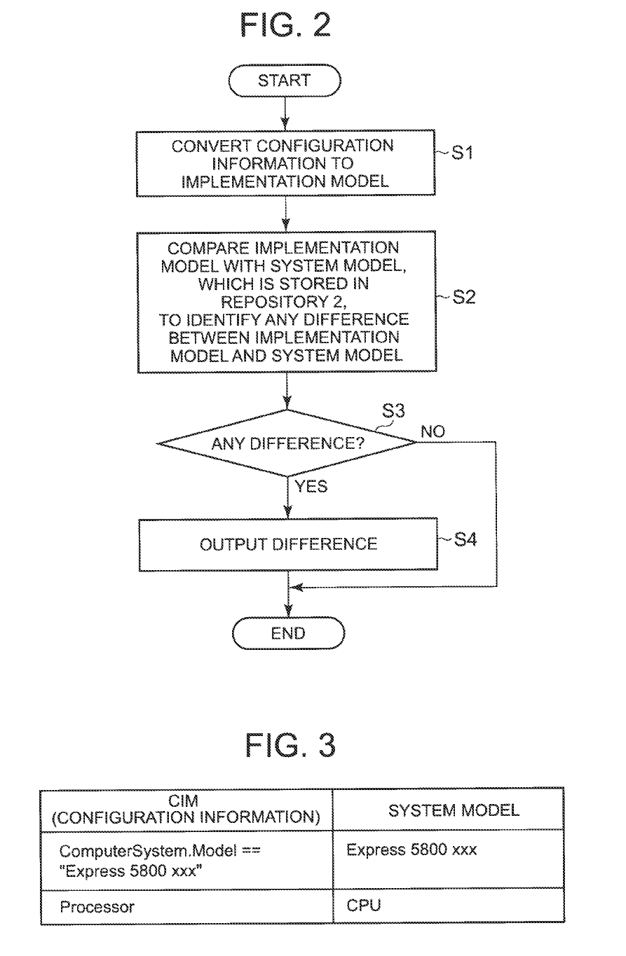

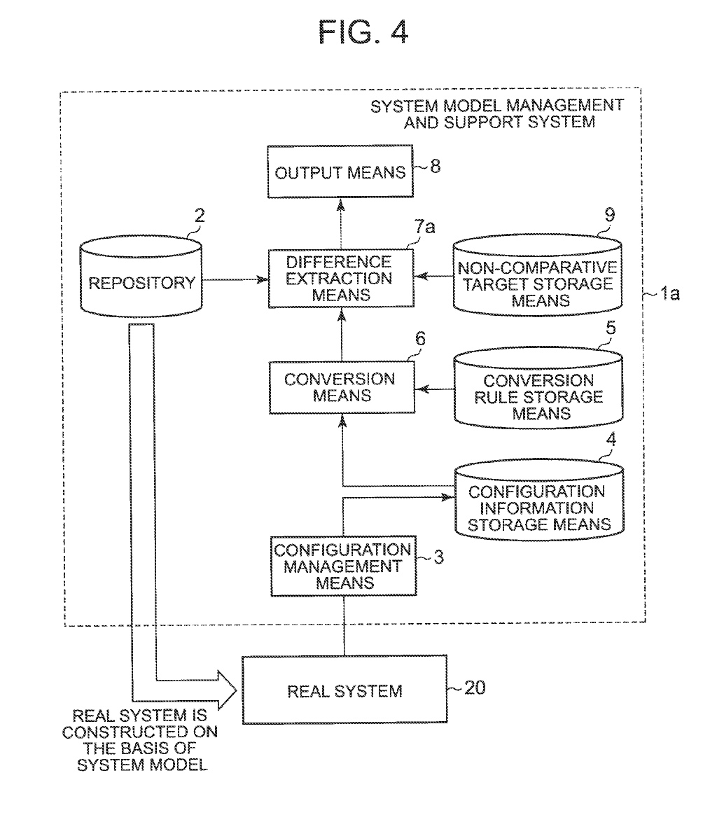

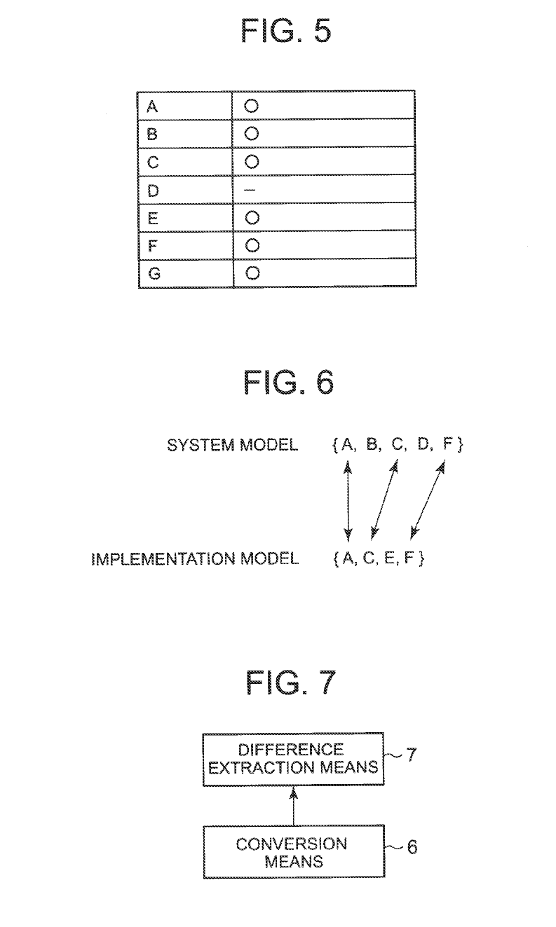

### BRIEF DESCRIPTION OF DRAWINGS

[FIG. 1] It depicts a block diagram illustrating an example of a system model management and support system according to a first exemplary embodiment of the present invention.

[FIG. 2] It depicts a flowchart illustrating exemplary processing steps performed by the system model management and support system according to the present invention.

[FIG. 3] It depicts an explanatory schematic diagram illustrating conversion rules for converting configuration information notations to system model notations.

[FIG. 4] It depicts a block diagram illustrating an example of the system model management and support system according to a second exemplary embodiment of the present invention.

[FIG. 5] It depicts an explanatory diagram illustrating exemplary information to be stored by non-comparative target storage means.

[FIG. 6] It depicts an explanatory diagram illustrating an exemplary comparison between a system model and an implementation model.

[FIG. 7] It depicts a block diagram illustrating an example of a minimum configuration of the present invention.

### DESCRIPTION OF EMBODIMENTS

Embodiments of the present invention will now be described with reference to the accompanying drawings.

### First Exemplary Embodiment

FIG. 1 is a block diagram illustrating an example of a system model management and support system according to a first exemplary embodiment of the present invention. The system model management and support system 1 according to the first exemplary embodiment includes a repository 2, configuration management means 3, configuration information storage means 4, conversion rule storage means 5, conversion means 6, difference extraction means 7, and output means 8.

The repository 2 is a storage device for storing a system model that is expressed by abstracting the configuration and operation of a real system. The system model expresses what software and hardware are employed to configure the real system and how the hardware operates. The system model is described in a machine-processable modeling language such as UML (Unified Modeling Language) or SysML (Systems Modeling Language). However, the language used to describe the system model is not limited to UML and SysML. The system model may be described in a different language. The machine-processable language is a language whose expressions can be subjected to information processing. Therefore, the system model can be subjected, for instance, to comparison operation with respect to some other model.

The system model stored in the repository 2 is read and customized by a system developer to develop the real system 20.

The configuration information storage means 4 is a storage device for storing configuration information indicative of the configuration and settings of the developed real system 20. For example, the configuration information storage means 4 stores the configuration information that describes hardware and software included in the real system 20 and settings applied to the hardware and software.

The configuration information is described, for instance, in a CIM (Common Information Model). However, the CIM is an example. The configuration information may be expressed in a model other than CIM.

The configuration management means 3 manages the configuration information stored in the configuration information storage means 4 in accordance with the status of real system 20. When, for instance, the configuration management means 3 detects that a developer of the real system 20 added new hardware or software to the real system 20, removed the hardware or software, or changed the settings of the hardware or software, the configuration management means 3 updates the configuration information stored in the configuration information storage means 4 in accordance with the addition, removal, or setting change of the hardware or software. The configuration management means 3 may collect the configuration information from the real system 20 by a known method and store the collected configuration information in the configuration information storage means 4.

The configuration management means 3 may be provided in the real system 20 to operate in accordance with an agent. Alternatively, the configuration management means 3 may inquire about the configuration and settings of the real system 20 from the outside of the real system 20 and update the configuration information stored in the configuration information storage means 4 in accordance with the results of the inquiry.

The conversion means 6 converts the configuration information stored in the configuration information storage means 4, that is, the information indicative of the configuration and settings of the real system 20, to a model having the same expression form as the system model stored in the repository 2. In accordance with conversion rules stored in the conversion rule storage means 5, the conversion means 6 converts the configuration information to a model having the same expression form as the system model. The model obtained when the conversion means 6 converts the configuration information is referred to as an implementation model. The implementation model is expressed in the same expression form as the system model stored in the repository 2. If, for instance, the system model stored in the repository 2 is described in SysML, the implementation model is also described in SysML.

The conversion rule storage means 5 is a storage device for storing conversion rules that are used to convert the configuration information to a model having the same expression form as the system model stored in the repository 2. If, for instance, the configuration information stored in the configuration information storage means 4 is described in CIM while the system model stored in the repository 2 is described in SysML, the conversion rule storage means 5 may store in advance the conversion rules for converting the configuration information described in CIM to an expression form based on SysML. The conversion rules may be predefined in accordance with the description format for the configuration information and with the description format for the system model stored in the repository 2.

The difference extraction means 7 compares the system model stored in the repository 2 with the implementation model converted from the configuration information by the conversion means 6, and if there is any difference between the system model and the implementation model, the difference extraction means 7 identifies the difference. The system model compared with the implementation model is used during the development of the real system 20.

The output means 8 is an output device for outputting the difference identified by the difference extraction means 7. The output means 8 is implemented, for instance, by a display device that displays the difference identified by the difference extraction means 7. However, the mode of difference output is not limited to a display output. The output means 8 may alternatively be implemented by an output device other than a display device, such as a printing device that prints out the difference.

The configuration management means 3, the conversion means 6, and the difference extraction means 7 are implemented, for instance, by a computer's CPU that operates in accordance with a system model management and support program. In this instance, a computer's program storage device (not shown) may store the system model management and support program and allow the CPU to read the program and operate as the configuration management means 3, the conversion means 6, and the difference extraction means 7 in accordance with the program.

Further, the configuration management means 3, the conversion means 6, and the difference extraction means 7 may alternatively be implemented by separate units. Furthermore, as mentioned earlier, the configuration management means 3 may alternatively be provided in the real system 20 to operate in accordance with an agent.

The operation will now be described.

FIG. 2 is a flowchart illustrating exemplary processing steps performed by the system model management and support system according to the present invention. In an example described below, it is assumed that the configuration management means 3 creates configuration information in accordance with the latest status of the real system 20 and stores the configuration information in the configuration information storage means 4. When, for instance, the addition or removal of hardware or software in the real system 20 is detected or changes in the settings of the hardware or software are detected, the configuration management means 3 updates the configuration information stored in the configuration information storage means 4 in accordance with the latest status.

The conversion means 6 converts the configuration information stored in the configuration information storage means 4 to an implementation model in accordance with the conversion rules (step S1). In other words, the conversion means 6 converts the configuration information to a model having the same expression form as the system model.

If, for instance, the configuration information is described in CIM and the system model stored in the repository 2 is described in SysML, the conversion rule storage means 5 stores in advance the conversion rules for converting the configuration information described in CIM to an expression form based on SysML. In this instance, the conversion means 6 converts, in step S1, the configuration information described in CIM to an implementation model described in SysML in accordance with the stored conversion rules.

Further, if the conversion rules are such that configuration information notations differ from system model notations, the conversion rules may include a conversion rule for associating the configuration information notations with the system model notations and converting the configuration information notations to the system model notations.

FIG. 3 is an explanatory schematic diagram illustrating the conversion rules for converting the configuration information notations to the system model notations. In the example shown in FIG. 3, the left-hand column shows the configuration information notations, whereas the right-hand column shows the system model notations. If the conversion rules schematically shown in FIG. 3 are established, the conversion means 6 may generate an implementation model that uses a notation in the right-hand column in place of a notation in the left-hand column that is included in the configuration information. For example, if the term “Processor” is used in the configuration information, the conversion to the implementation model may be effected so that an element corresponding to “Processor” is expressed as “CPU” in the implementation model. FIG. 3 shows exemplary conversion rules. The conversion rules need not always be defined in a tabular form shown in FIG. 3. It should be noted that “Express 5800” in FIG. 3 is a trademark.

As far as the configuration information notations are associated with the system model notations as shown in FIG. 3 to define the conversion rules for converting the configuration information notations to the system model notations, a conversion process can be smoothly performed even when the granularity of elements indicated by the configuration information is relatively close to, but not identical with, the granularity of elements in the system model.

After completion of step S1, the difference extraction means 7 compares the implementation model with the system model stored in the repository 2 to identify any difference between the implementation model and the system model (step S2). As the implementation model has the same expression form as the system model, the implementation model can be compared with the system model. In other words, the implementation model and the system model can be compared as they are described in the same language.

In step S2, if there is any difference between the implementation model and the system model, the difference extraction means 7 identifies the difference. More specifically, the difference extraction means 7 extracts any difference between the implementation model and the system model.

If the difference extraction means 7 has extracted any difference between the implementation model and the system model (if the query in step S3 is answered “YES”), the difference extraction means 7 outputs the difference to the output means 8 (step S4). For example, the difference extraction means 7 causes a display device to display the difference between the implementation model and the system model. The mode of output in step S4 is not limited to a display output.

If, on the other hand, the difference extraction means 7 has extracted no difference because there is no difference between the implementation model and the system model (if the query in step S3 is answered “NO”), the difference extraction means 7 terminates the process immediately. In this instance, the difference extraction means 7 may output information to the output means 8 to indicate that there is no difference between the implementation model and the system model.

The present invention converts the configuration information indicative of the status of the real system 20 to a model (implementation model) having the same expression form as the system model used during the development of the real system 20 and compares the implementation model with the system model. If there is any difference between the implementation model and the system model, the present invention outputs the difference. Therefore, an inconsistency arising between the system model and the real system 20 when a change not reflected in the system model is applied to the real system 20 can be reported to the system developer to make it easy for the system developer to manage the system model. The system developer having an understanding of the inconsistency can modify the system model to resolve the difference and update the system model in accordance with the latest status of the real system 20. This makes it possible to prevent the system model from becoming obsolete.

### Second Exemplary Embodiment

FIG. 4 is a block diagram illustrating an example of the system model management and support system according to a second exemplary embodiment of the present invention. Elements identical with those of the first exemplary embodiment are designated by the same reference numerals as the corresponding elements shown in FIG. 1 and will not be described in detail. The system model management and support system la according to the second exemplary embodiment includes a repository 2, configuration management means 3, configuration information storage means 4, conversion rule storage means 5, conversion means 6, difference extraction means 7a, output means 8, and non-comparative target storage means 9.

The repository 2, the configuration management means 3, the configuration information storage means 4, the conversion rule storage means 5, the conversion means 6, and the output means 8 are identical with the corresponding elements of the first exemplary embodiment and will not be redundantly described.

The non-comparative target storage means 9 is a storage device for storing information that is described in the system model and indicates in advance that the judgment of whether the system model differs from the implementation model is not executed. More specifically, the non-comparative target storage means 9 stores the information that defined the target which is not compared between the system model and the implementation model. FIG. 5 shows exemplary information to be stored in the non-comparative target storage means 9. The symbols “A” to “G” in FIG. 5 represent items of information that are described in the system model. The non-comparative target storage means 9 stores information indicating that if the judgment of whether the system model differs from the implementation model is executed or not, the information being associated with the items of information. In the example shown in FIG. 5, the symbol “o” indicates that the judgment for difference between the system model and the implementation model is executed, whereas the symbol “−” indicates that the judgment for difference between the system model and the implementation model is not executed. The example shown in FIG. 5 shows that in terms of information “A,” the judgment for difference between the system model and the implementation model is executed, while in terms of information “D,” the judgment for difference between the system model and the implementation model is not executed.

As the information indicating that the judgment for difference between the system model and the implementation model is not executed, the information that indicates the configuration or operation of the real system 20 and cannot be collected from the real system 20 by the configuration management means 3 may be identified beforehand and stored in the non-comparative target storage means 9. For example, the information about “inter-process communication” may be described in the system model but cannot be collected from the real system 20 in some cases. In such an instance, the non-comparative target storage means 9 may store, in advance, relevant information as to “inter-process communication,” and the judgment for difference between the system model and the implementation model is not executed.

The difference extraction means 7a compares items of information between the system model and the implementation model except for items of information that are defined by the non-comparative target storage means 9 as the information indicating that the judgment for difference between the system model and the implementation model is not executed. If there is any difference between the system model and the implementation model, the difference extraction means 7a extracts the difference. The difference extraction means 7a does not compare items of information between the system model and the implementation model as far as the items of information are defined as the information indicating that the judgment for difference between the system model and the implementation model is not executed. If, for instance, the information about “inter-process communication” is defined as the information indicating that the judgment for difference is not executed, as indicated in the above example, the difference extraction means 7a does not make comparison between the system model and the implementation model to check for difference in the information about “inter-process communication.” As regards the other items of information, however, the difference extraction means 7a makes comparison between the system model and the implementation model, as is the case with the first exemplary embodiment.

The operation performed by the second exemplary embodiment is described in the same flowchart as for the first exemplary embodiment. In step S2, however, the difference extraction means 7a compares items of information between the system model and the implementation model except for items of information that are defined as the information indicating that the judgment for difference between the system model and the implementation model is not executed. If there is any difference between the system model and the implementation model, the difference extraction means 7a extracts the difference. As described earlier, the difference extraction means 7a does not compare items of information between the system model and the implementation model as far as the items of information are defined as the information indicating that the judgment for difference between the system model and the implementation model is not executed. In the other respects, the operation performed by the second exemplary embodiment is the same as the operation performed by the first exemplary embodiment.

If the information about “inter-process communication,” which cannot be included in the configuration information because it is not collected from the real system 20, is defined as the information indicating that the judgment for difference between the system model and the implementation model is executed, the information about “inter-process communication” is not described in the implementation model, therefore, the information about “inter-process communication” is always detected if the information about “inter-process communication” is described in the system model. Then, although the inter-process communication described in the system model is implemented as is in the real system 20, a result output may be generated to indicate that the description of the system model differs from the description of the real system 20. As for items of information that are defined as the information indicating that the judgment for difference between the system model and the implementation model is not executed, the second exemplary embodiment does not compare between the system model and the implementation model. This prevents the generation of a result output indicating that the description of the system model differs from the description of the real system 20 although it is possible that the contents of the system model are implemented by the real system 20.

A concrete example of step S2 in the second exemplary embodiment will now be described. It is assumed that the non-comparative target storage means 9 stores the information illustrated to FIG. 5, and that the symbols “A” to “G” represent nodes that can be described in the system model. FIG. 6 is an explanatory diagram illustrating an exemplary comparison between the system model and the implementation model. As shown in FIG. 6, it is assumed that nodes A, B, C, D, and F are described in the system model. Meanwhile, it is assumed that nodes A, C, E, and F are described in the implementation model. Node D is described in the system model, but is not described in the implementation model. However, it is specified that node D is not to be compared between the system model and the implementation mode to check for difference therebetween (see FIG. 5). Therefore, the difference extraction means 7a does not compare node D between the system model and the implementation model to check for difference therebetween, but compares the other nodes to check for difference therebetween. As a result, the difference extraction means 7a extracts node B, which is described in the system model but not in the implementation model, and node E, which is described in the implementation model but not in the system model, as the difference, and causes the output means 8 to output the description of the extracted difference. The system developer then recognizes that node B, which is described in the system model, does not exist in the real system 20, and that node E is newly added to the real system 20.

A minimum configuration of the present invention will now be described. FIG. 7 is a block diagram illustrating an example of the minimum configuration of the present invention. The system model management and support system according to the present invention includes the conversion means 6 and the difference extraction means 7.

The conversion means 6 converts the configuration information, which indicates the configuration and settings of the real system to be actually operated, to a model having the same expression form as the system model, which is used as a model representing the real system during the development of the real system.

The difference extraction means 7 compares the system model with a model converted from the configuration information to extract any difference between the system model and the model converted from the configuration information.

When there is any difference between the system model and the real system, the above-described configuration makes it possible to identify the difference and facilitate the management of the system model.

The configuration of the system model management and support system according to the foregoing exemplary embodiments is characterized as described under (1) to (10) below.

(1) The system model management and support system includes conversion means (e.g., conversion means 6) and difference extraction means (e.g., difference extraction means 7, 7a). The conversion means converts configuration information indicative of the configuration and settings of a real system (e.g., real system 20) into a model having the same expression form as a system model. The real system is actually operated as a system. The system model is used as a model representing the real system during the development of the real system. The difference extraction means extracts any difference between the system model and the model converted from the configuration information by comparing the system model with the model converted from the configuration information.

(2) The system model management and support system may further include non-comparative target storage means (e.g., non-comparative target storage means 9) for storing information that defined the target which is not compared between the system model and the model converted from the configuration information. The difference extraction means may compare items of information between the system model and the model converted from the configuration information except for items of information that are not to be subjected to comparison, and extract any difference between the system model and the model converted from the configuration information. The above-described configuration prevents a description of the system model from being judged to be different from a description of the real system although it is possible that the contents of the system model are implemented by the real system.

(3) In the system model management and support system, the conversion means may convert the configuration information to a model including system model notations in accordance with conversion rules including a conversion rule for converting configuration information notations to the system model notations. The above-described configuration makes it possible to smoothly perform a conversion process even when the granularity of elements indicated by the configuration information is relatively close to, but not identical with, the granularity of elements in the system model.

(4) The system model management and support system may further include configuration information collection means for collecting the configuration information from the real system.

(5) The system model management and support system may further include output means for outputting any difference between the system model and the model converted from the configuration information.

(6) The system model management and support system may include a conversion unit and a difference extraction unit. The conversion unit converts configuration information indicative of the configuration and settings of a real system into a model having the same expression form as a system model. The real system is actually operated as a system. The system model is used as a model representing the real system during the development of the real system. The difference extraction unit extracts any difference between the system model and the model converted from the configuration information by comparing the system model with the model converted from the configuration information.

(7) The system model management and support system may further include a non-comparative target storage unit for storing information that defined the target which is not compared between the system model and the model converted from the configuration information. The difference extraction means may compare items of information between the system model and the model converted from the configuration information except for items of information that are not to be subjected to comparison, and extract any difference between the system model and the model converted from the configuration information.

(8) In the system model management and support system, the conversion unit may convert the configuration information to a model including system model notations in accordance with conversion rules including a conversion rule for converting configuration information notations to the system model notations.

(9) The system model management and support system may further include a configuration information collection unit for collecting the configuration information from the real system.

(10) The system model management and support system may further include an output unit for outputting any difference between the system model and the model converted from the configuration information.

While the present invention has been described in connection with the foregoing exemplary embodiments, it should be understood that the present invention is not limited to the foregoing exemplary embodiments. The present invention extends to various modifications that nevertheless fall within the scope and spirit of the present invention.

This application is based upon and claims the benefit of priority from Japanese Patent Application No. 2009-251078, filed on Oct. 30, 2009, the disclosure of which is incorporated herein in its entirety by reference.

### INDUSTRIAL APPLICABILITY

The present invention is suitably applied to a system model management and support system for managing whether a system model used for design process reduction is maintained in a proper state.

### REFERENCE SIGNS LIST

1, 1a . . . System model management and support system
2 . . . Repository
3 . . . Configuration management means
4 . . . Configuration information storage means
5 . . . Conversion rule storage means
6 . . . Conversion means
7, 7a . . . Difference extraction means
8 . . . Output means
9 . . . Non-comparative target storage means
20 . . . Real system

1-9. (canceled)

10. A system model management and support system comprising:
a conversion unit for converting configuration information indicative of the configuration and settings of a real system into a model having the same expression form as a system model, the real system being actually operated as a system, the system model being used as a model representing the real system during the development of the real system; and
a difference extraction unit for extracting any difference between the system model and the model converted from the configuration information by comparing the system model with the model converted from the configuration information.

11. The system model management and support system according to claim 10, further comprising:
a non-comparative target storage unit for storing information that defined the target which is not compared between the system model and the model converted from the configuration information;
wherein the difference extraction unit compares items of information between the system model and the model converted from the configuration information except for items of information that are not to be subjected to comparison, and extracts any difference between the system model and the model converted from the configuration information.

12. The system model management and support system according to claim 10, wherein the conversion unit converts the configuration information to a model including system model notations in accordance with conversion rules including a conversion rule for converting configuration information notations to the system model notations.

13. The system model management and support system according to claim 10, further comprising:
a configuration information collection unit for collecting the configuration information from the real system.

14. The system model management and support system according to claim 10, further comprising:
an output unit for outputting any difference between the system model and the model converted from the configuration information.

15. A system model management and support method comprising the steps of:
converting configuration information indicative of the configuration and settings of a real system into a model having the same expression form as a system model, the real system being actually operated as a system, the system model being used as a model representing the real system during the development of the real system; and
extracting any difference between the system model and the model converted from the configuration information by comparing the system model with the model converted from the configuration information.

16. The system model management and support method according to claim 15, further comprising the steps of:
storing information that defined the target which is not compared between the system model and the model converted from the configuration information; and
comparing items of information between the system model and the model converted from the configuration information except for items of information that are not to be subjected to comparison, and extracting any difference between the system model and the model converted from the configuration information.

17. A computer readable information recording medium storing a system model management and support program, when executed by a processor, performs a method for:
converting configuration information indicative of the configuration and settings of a real system into a model having the same expression form as a system model, the real system being actually operated as a system, the system model being used as a model representing the real system during the development of the real system; and
extracting any difference between the system model and the model converted from the configuration information by comparing the system model with the model converted from the configuration information.

18. The computer readable information recording medium according to claim 17, the computer having a non-comparative target storage unit, further comprising:
storing information that defined the target which is not compared between the system model and the model converted from the configuration information; and
comparing items of information between the system model and the model converted from the configuration information except for items of information that are not to be subjected to comparison, and extract any difference between the system model and the model converted from the configuration information.
